(19) United States
(12) Patent Application Publication
(10) Pub. No.: US 2025/0243896 A1
(43) Pub. Date: Jul. 31, 2025

(54) FIXING ASSEMBLY INCLUDING CLEVIS AND TANG

(71) Applicant: SKF Aerospace France S.A.S, Perrigny (FR)

(72) Inventors: Florent Denis Fauchery, Montmeyran (FR); Florian Vincent BARDY, Perrigny (FR); Eric Jean-Marie DENEUX, Metz (FR)

(21) Appl. No.: 19/033,704

(22) Filed: Jan. 22, 2025

(30) Foreign Application Priority Data
Jan. 31, 2024 (FR) 2400941

(51) Int. Cl. F16C 11/04

(52) U.S. Cl. CPC F16C 11/045

(57) ABSTRACT

A fixing assembly includes a clevis having two arms, a tang extending between the arms, and a clevis pin extending through the arms and the tang to connect the tang to the clevis. A first contact assembly has a first cylinder having a bore and a first flange and a second cylinder having a bore and a second flange. The first cylinder extends into the bore of the first arm from a first side of the first arm, and the second cylinder extends into a portion of the bore of first cylinder located inside the bore of the first arm from a second side of the first arm. The first or second flange axially faces or contacts a first lateral face of the tang, and a first axial space exists between the first arm and the first lateral face of the tang.

### CROSS-REFERENCE

This application claims priority to French patent application no. 2400941 filed on Jan. 31, 2024, the contents of which are fully incorporated herein by reference.

### TECHNOLOGICAL FIELD

The present disclosure is directed to clevises and an assembly of a clevis fork and a tang to fix a clevis and a tang onto a clevis pin. More specifically, the disclosure is directed to a fixing assembly comprising a clevis pin, a clevis provided with two connecting portions, and a tang.

### BACKGROUND

As represented in FIG. 1, an existing fixing assembly 1 comprises a fork of a clevis 2 having two connecting portions 3 and 4. A tang 5 is mounted on a clevis pin 6 to fix the clevis 2 and the tang 5 around a fixing axis X. The two connecting portions 3 and 4 are generally formed of a plastic material reinforced with carbon fibers, and the tang is generally formed of a metal such as aluminum. Conventionally, two contact rings 7 and 8 are disposed radially between the clevis pin 6 and the connecting portions 3 and 4.

The proximity and the contacts resulting from fixing the clevis 2 and the tang 5 lead to the appearance of galvanic corrosion at the interface between the connecting portions 3 and 4 and the tang 5. Now, this phenomenon leads to premature wear of the fixing assembly 1.

In order to eliminate this risk of galvanic corrosion, it is known to deposit a layer 9, 10 of plastic material reinforced with glass fibers, generally in ply form, on the surface of the connecting portions 3 and 4 that come into contact with the tang 5. However, adding such a layer 9, 10 on the connecting portions of the clevis increases the weight of the fixing assembly 1. Given its nature and its manufacturing steps, the layer 9, 10 also makes producing the fixing assembly 1 particularly costly. Furthermore, the presence of glass fibers in the layer 9, 10 prevents recycling of the carbon fibers of the plastic material reinforced with carbon fibers of the connecting portions 3 and 4 of the clevis 2 after the fixing assembly 1 is discarded.

### SUMMARY

An aspect of the disclosure comprises remedying these disadvantages and provides a simple and easy-to-implement configuration of a fixing assembly that includes a clevis pin, a clevis and a tang that allows the formation of galvanic corrosion at the interface between the clevis and the tang to be eliminated.

The disclosed fixing assembly comprising a clevis pin, a clevis provided with first and second connecting portions, and a tang. The first and second connecting portions of the clevis and the tang are positioned around the clevis pin, and the tang is disposed on the clevis pin axially between the first and second connecting portions of the clevis.

The fixing assembly further includes a first contact assembly disposed radially between the bore of the first connecting portion of the clevis and the clevis pin, which first contact assembly includes first and second rings driven at least partially onto one another. The second ring is positioned in the bore of the first ring such that at least one of the first and second rings comes to bear axially against a first lateral face of the tang or facing the first lateral face. The fixing assembly also includes a second contact assembly disposed radially between the bore of the second connecting portion of the clevis and the clevis pin, which second contact assembly includes third and fourth rings driven at least partially onto one another. The fourth ring is positioned in the bore of the third ring such that at least one of the third and fourth rings comes to bear axially against a second lateral face of the tang or faces the second lateral face that is axially opposite the first lateral face of the tang. A first axial space is formed between the first connecting portion of the clevis and the first face of the tang, and a second axial space is formed between the second connecting portion of the clevis and the second face of the tang.

In one embodiment, the first ring and/or the second ring may each come to bear axially against the first lateral face of the tang or to face the first lateral face, and the third ring and/or the fourth ring may each come to bear axially against the second lateral face of the tang or to face the second lateral face axially opposite the first lateral face of the tang.

In accordance with one feature, the first ring and the second ring may comprise at least one axial portion having a front face in contact with the first lateral face of the tang or facing the first lateral face, and the third ring and the fourth ring may comprise at least one axial portion having a front face in contact with the second lateral face of the tang or facing the second lateral face.

In accordance with an alternative, only one of the first and second rings may have the at least one axial portion provided with a front face in contact with the first lateral face of the tang or facing the first lateral face, and only one of the third and fourth rings may have the at least one axial portion provided with a front face in contact with the second lateral face of the tang or facing the second lateral face.

In accordance with one embodiment, the first ring comprises a radial flange that extends in the first axial space radially outward from the axial portion and that has a contact surface in contact with the first lateral face of the tang or facing the first lateral face and extending radially outward from the front face of the axial portion, and the third ring comprises a radial flange that extends in the second radial space radially outward from the axial portion and that has a contact surface in contact with the second lateral face of the tang or facing the second lateral face and radially extending outward the front face of the axial portion.

The radial flange of the first ring preferably comprises a bearing surface axially opposite the contact surface that comes axially into contact with a first face of the first connecting portion of the clevis, which is disposed facing the first lateral face of the tang. The radial flange of the third ring preferably comprises a bearing surface axially opposite the contact surface that comes axially into contact with a first face of the second connecting portion of the clevis disposed facing the second lateral face of the tang.

The second ring preferably further comprises a radial flange that extends outward from the axial portion and that has a bearing surface that comes into contact with a second face of the first connecting portion of the clevis opposite a first face disposed facing the first lateral face of the tang. The fourth ring preferably further comprises a radial flange that extends outward from the axial portion and that has a bearing surface coming into contact with a second face of the second connecting portion of the clevis opposite a first face disposed facing the second lateral face of the tang.

The periphery of the radial flange of the first ring and the periphery of the radial flange of the third ring may advantageously each include a chamfer. Alternatively or in combination, the periphery of the radial flange of the second ring and the periphery of the radial flange of the fourth ring may each comprise a chamfer.

In another embodiment, the second ring may comprise a radial flange that extends in the first axial space radially outward from the axial portion and that is provided with a contact surface in contact with the first lateral face of the tang or facing the first lateral face and that extends radially outward from the front face of the axial portion. The fourth ring may comprise a radial flange that extends in the second radial space radially outward from the axial portion and that is provided with a contact surface in contact with the second lateral face of the tang or facing the second lateral face and that extends radially outward from the front face of the axial portion.

The radial flange of the second ring preferably comprises a bearing surface axially opposite the contact surface that comes axially into contact with a first face of the first connecting portion of the clevis disposed facing the first lateral face of the tang, and the radial flange of the fourth ring preferably comprises a bearing surface axially opposite the contact surface that comes axially into contact with a first face of the second connecting portion of the clevis disposed facing the second lateral face of the tang.

The first ring preferably further comprises a radial flange that extends outward from the axial portion and that has a bearing surface that comes into contact with a second face of the first connecting portion of the clevis opposite a first face disposed facing the first lateral face of the tang, and the third ring preferably comprises a radial flange that extends outward from the axial portion, and that has a bearing surface that into contact with a second face of the second connecting portion of the clevis opposite a first face facing the second lateral face of the tang.

The periphery of the radial flange of the second ring and the periphery of the radial flange of the fourth ring may advantageously each comprise a chamfer. Alternatively or in combination, the periphery of the radial flange of the first ring and the periphery of the radial flange of the third ring may each comprise a chamfer. The material of the first and second connecting portions of the clevis advantageously comprises a thermoplastic or thermoset matrix reinforced by carbon fibers. The tang advantageously comprises a metal, such as aluminum or an aluminum alloy.

### BRIEF DESCRIPTION OF THE DRAWINGS

Other aims, advantages and features will become apparent from the following description given purely by way of illustration and with reference to the appended drawings, in which:

FIG. 1 is a sectional elevational view of a prior art fixing assembly for fixing a clevis and a tang.

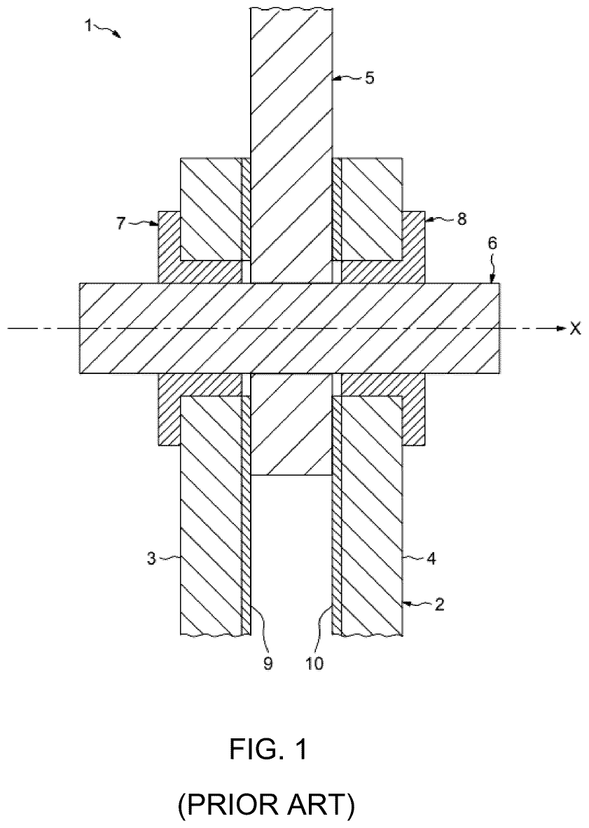

FIG. 2 is a sectional elevational view of a fixing assembly having includes a clevis and a tang according to a first embodiment of the present disclosure.

FIG. 3 is a sectional elevational view of a fixing assembly having includes a clevis and a tang according to a second embodiment of the present disclosure.

FIG. 4 is a sectional elevational view of a fixing assembly having includes a clevis and a tang according to a third embodiment of the present disclosure.

### DETAILED DESCRIPTION

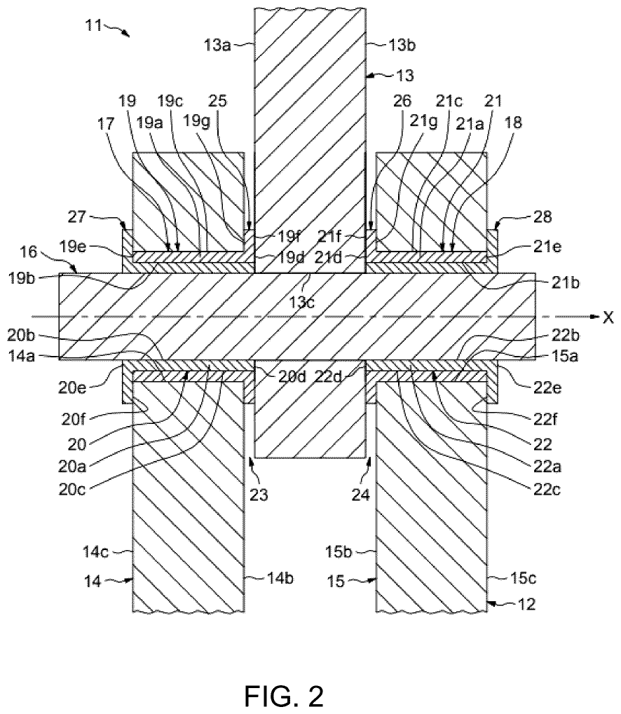

FIG. 2 illustrates a fixing assembly 11 in accordance with a first embodiment of the present disclosure that includes a clevis 12 and a tang 13. The clevis 12 comprises at least one forked end that forms a clevis fork and has first and second connecting portions 14 and 15 (sometimes referred to hereinafter as first and second “arms”).

The first connecting portion 14 has a first face 14b and a second face 14c axially opposite the first face 14b. The thickness of the first connecting portion 14 is delimited by the first and second faces 14b and 14c. Similarly, the second connecting portion 15 has a first face 15b and a second face 15c axially opposite the first face 15b. The thickness of the second connecting portion 15 is delimited by the first and second faces 15b and 15c.

The tang 13 and the first and second connecting portions 14 and 15 of the clevis 12 are positioned around a common clevis pin 16 of the assembly. The clevis pin 16 extends along an axis X through the first and second connecting portions 14, 15 and the tang 13. Furthermore, the tang 13 is disposed on the clevis pin 16 axially between the first and second connecting portions 14 and 15 of the clevis 12.

The tang 13 has a first lateral face 13a and a second lateral face 13b axially opposite the first lateral face 13a. The first and second lateral faces 13a and 13b delimit the thickness of the tang 13. The tang 13 also has a bore 13c against which the exterior surface of the clevis pin 16 bears.

The fixing assembly 11 further includes first and second contact assemblies 17 and 18. The first contact assembly 17 is disposed radially between the clevis pin 16 and the bore 14a of the first connecting portion 14 of the clevis 12. The first contact assembly 17 includes an exterior first ring 19 and an interior second ring 20 driven one into the other.

The first ring 19 has an axial portion 19a (first cylinder) that surrounds a bore 19b and has an exterior surface 19c radially opposite the bore 19b and axially opposite first and second front faces 19d and 19e that delimit the axial length of the axial portion 19a. Similarly, the second ring 20 has an axial portion 20a (second cylinder) that surrounds a bore 20b and an exterior surface 20c radially opposite the bore 20b and axially opposite first and second front faces 20d and 20e that delimit the axial length of the axial portion 20a.

The second ring 20 is positioned in the bore 19b of the first ring 19 so that the exterior surface 20c of the second ring 20 is positioned in contact with the bore 19b of the first ring 19. The second contact assembly 18 is disposed radially between the clevis pin 16 and the bore 15a of the second connecting portion 15 of the clevis 12.

The second contact assembly 18 includes an exterior third ring 21 and an interior fourth ring 22 driven one into the other. The third ring 21 advantageously has an axial portion 21a (third cylinder) that surrounds a bore 21b and an exterior surface 21c radially opposite the bore 21b and axially opposite first and second front faces 21d and 21e that delimit the axial length of the axial portion 21a. The fourth ring 22 has an axial portion 22a (fourth cylinder) that has a bore 22b, an exterior surface 22c radially opposite the bore 22b, and axially opposite first and second front faces 22d and 22e that delimit the axial length of the axial portion 22a.

The fourth ring 22 is positioned in the bore 21b of the third ring 21 so that the exterior surface 22c of the fourth ring 22 is positioned in contact with the bore 21b of the third ring 21.

The bore 20b of the axial portion 20 of the second ring 20 and the bore 22b of the axial portion 22 of the fourth ring 22 are positioned against the exterior surface of the clevis pin 16. The exterior surface 19c of the axial portion 19 of the first ring 19 and the exterior surface 21c of the axial portion 21 of the third ring 21 are respectively positioned against the bore 14a of the first connecting portion 14 and against the bore 15a of the second connecting portion 15.

The first and second rings 19 and 20 are fixed to the fixing assembly 11 by a press fit between the first connecting portion 14 of the clevis 12 and the clevis pin 16. Similarly, the third and fourth rings 21 and 22 are fixed to the fixing assembly 11 by a press fit between the second connecting portion 15 of the clevis 12 and the clevis pin 16.

In the example depicted in FIG. 2, the first ring 19 bears axially against a first lateral face 13a of the tang 13, and the third ring 21 bears axially against the second lateral face 13b of the tang 13. Furthermore, a first axial space 23 is formed between the first connecting portion 14 of the clevis 12 and the first face 13a of the tang 13. Similarly, a second axial space 24 is formed between the second connecting portion 15 of the clevis 12 and the second face 13b of the tang 13.

Such a configuration of the fixing assembly 11 enables elimination by simple, fast and relatively low cost means of the risks of occurrence of galvanic corrosion caused by contact between the clevis 12 and the tang 13.

The contact between the first ring 19 and the tang 13 and the contact between the second ring 20 and the tang 13 respectively creates the first axial space 23 and the second axial space 24 and thus maintains the first and second connecting portions 14, 15 of the clevis 12 at a distance from the tang 13.

Furthermore, the presence of the first and second axial spaces 23 and 24 between the first and second connecting portions 14, 15 of the clevis 12 and the tang 13 eliminates the requirement to have a smooth surface on the first face 14b, 15b of the first and second connecting portions 14, 15. The manufacture of the fixing assembly 11 thus does not require a step of finishing or re-machining the first faces 14b and 15b of the first and second connecting portions 14, 15. The first and second connecting portions 14, 15 may thus be used directly as cast or formed.

The contact assembly 17 is installed by driving the first and second rings 19 and 20 between the first connecting portion 14 of the clevis 12 and the clevis pin 16, and the contact assembly 18 is installed by driving the third and fourth rings 21 and 22 into the second connecting portion 15 of the clevis 12.

This press fit requires no additional mechanisms, such as glue, for fixing the contact assemblies 17 and 18. Installation is simple and rapid, without the requirement for, as would be the case for example for fixing by gluing, a time to prepare the interior surface of the clevis 12 and the exterior surface of the clevis pin 16, nor any application, curing, or cleaning time.

In the example depicted, the first and second rings 19 and 20 bear axially against the first lateral face 13a of the tang 13, and the third and fourth rings 21 and 22 come to bear axially against the second lateral face 13b of the tang 13. The first front face 19d of the axial portion 19a of the first ring 19 and the first front face 20d of the axial portion 20a of the second ring 20 are positioned in contact with the first lateral face 13a of the tang 13. Furthermore, the first front face 21d of the axial portion 21a of the third ring 21 and the first front face 22d of the axial portion 22a of the fourth ring 22 are positioned in contact with the second lateral face 13b of the tang 13.

In the first embodiment depicted in FIG. 2, the first ring 19 includes a radial flange 25 that extends radially in the first axial space 23. The radial flange 25 of the first ring 19 forms a radial portion of the first ring 19 that extends radially outward from the axial portion 19a and radially outward from the first front face 19d of the axial portion 19a. The radial flange 25 of the first ring 19 has a contact surface 19f in contact with the first lateral face 13a of the tang 13. In the example depicted, the radial flange 25 of the first ring 19 also has a bearing surface 19g axially opposite the contact surface 19f that axially contacts the first face 14b of the first connecting portion 14 of the clevis 12.

Similarly, the third ring 21 has a radial flange 26 that extends radially in the second radial space 24. The radial flange 26 forms a radial portion of the third ring 21 that extends radially outward from the axial portion 21a and extends radially outward from the first front face 21d of the axial portion 21a. The radial flange 26 of the third ring 21 has a contact surface 21f in contact with the second lateral face 13b of the tang 13. In the example depicted, the radial flange 26 of the third ring 21 includes a bearing surface 21g axially opposite the contact surface 21f that contacts the first face 15b of the second connecting portion 15 of the clevis 12 disposed facing the second lateral face 13b of the tang 13.

The second ring 20 preferably further comprises a radial flange 27 that extends outward from the axial portion 20a and has a bearing surface 20f that contacts the second face 14c of the first connecting portion 14 of the clevis 12. The second front face 20e of the second ring 20 is extended by the radial flange 27.

Similarly, the fourth ring 22 further has a radial flange 28 that extends outward from the axial portion 22a and that has a bearing surface 22f that contacts a second face 15c of the second connecting portion 15 of the clevis 12. The second front face 22e of the fourth ring 22 is extended by the radial flange 28.

In the embodiment shown in FIG. 2, the front face 19d of the first ring 19, the contact surface 19f of the first ring 19 and the front face 20d of the second ring 20 are disposed in contact with the first lateral face 13a of the tang 13. In a variant embodiment, the front face 19d, the contact surface 19f of the first ring 19 and the front face 20d of the second ring 20 may be disposed such that they face the first lateral face 13a of the tang 13 with a slight clearance possibly being present between the first lateral face 13a of the tang 13 and the first and second rings 19, 20.

Similarly, in the embodiment shown in FIG. 2, the front face 21d of the third ring 21, the contact surface 21f of the third ring 21 and the front face 22d of the fourth ring 22 are disposed in contact with the second lateral face 13b of the tang 13. In a variant embodiment, the front face 21d and the contact surface 21f of the third ring 21 and the front face 22d of the fourth ring 22 may be disposed such that they face the second lateral face 13b of the tang 13 with a slight clearance possibly being present between the second lateral face 13b of the tang 13 and the third and fourth rings 21, 22.

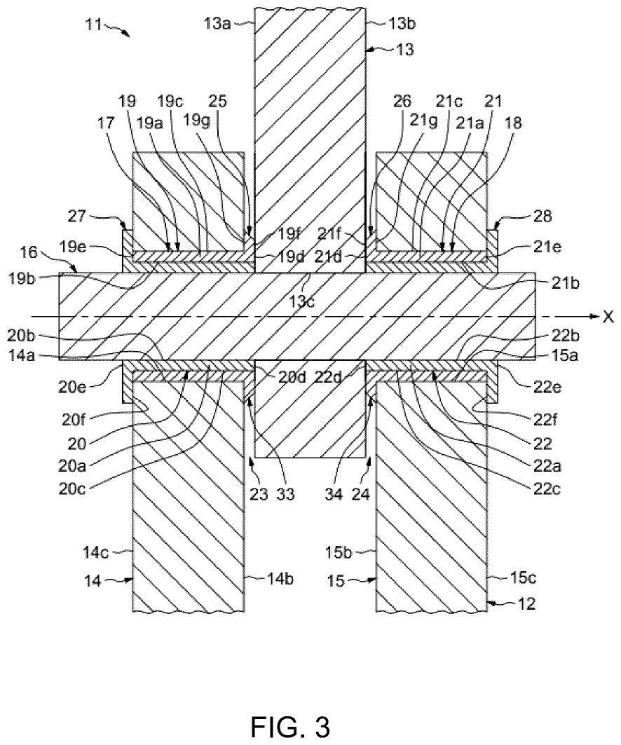

A second embodiment of the disclosure is depicted in FIG. 3, in which elements identical to elements of the first embodiment depicted in FIG. 2 are identified by the same reference numerals. In this embodiment, the periphery of the radial flange 25 of the first ring 19 and the periphery of the radial flange 26 of the third ring 21 may each have a chamfer 33 and 34, respectively. The periphery of the radial flange 27 of the second ring and the periphery of the radial flange 28 of the fourth ring may advantageously also each comprise a chamfer.

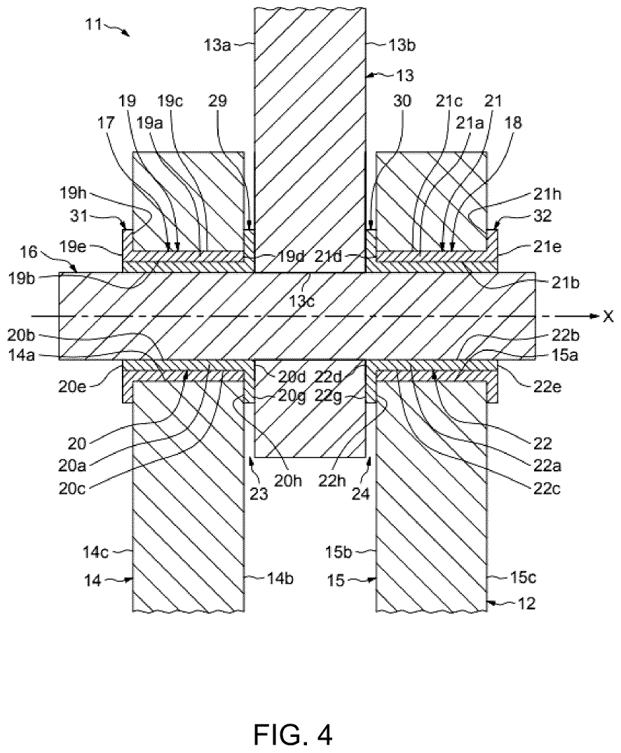

A third embodiment of the disclosure is depicted in FIG. 4 in which elements identical to the elements of the first embodiment depicted in FIG. 2 bear the same references. In the example depicted, the second ring 20 comprises a radial flange 29 that extends radially in the first axial space 23. The radial flange 29 of the second ring 20 extends outward from the axial portion 20a and has a contact surface 20g in contact with the first lateral face 13a of the tang 13 and extending radially outward from the first front face 20d of the axial portion 20a.

The radial flange 29 of the second ring 20 preferably comprises a bearing surface 20h axially opposite the contact surface 20g that axially contacts the first face 14b of the first connecting portion 14 of the clevis 12. Similarly, the fourth ring 22 comprises a radial flange 30 that extends radially in the second radial space 24.

The radial flange 30 extends outward from the axial portion 22a and is provided with a contact surface 22g in contact with the second lateral face 13b of the tang 13 and radially extending outward the first front face 22d of the axial portion 22a. The radial flange 30 of the fourth ring 22 preferably comprises a bearing surface 22h axially opposite the contact surface 22g and coming axially into contact with a first face 15b of the second connecting portion 15 of the clevis 12.

The first ring 19 preferably further comprises a radial flange 31 that extends outward the axial portion 19a. The radial flange 31 of the first ring 19 is advantageously provided with a bearing surface 19h coming into contact with the second face 14c of the first connecting portion 14 of the clevis 12. The second front face 19e of the first ring 19 is extended by the radial flange 31. Similarly, the third ring 21 further comprises a radial flange 32 that extends outward the axial portion 21a.

The radial flange 32 of the third ring 21 is provided with a bearing surface 21h coming into contact with a second face 15c of the second connecting portion 15 of the clevis 12. The second front face 21e of the third ring 21 is extended by the radial flange 32.

In the example depicted, the first front face 19d of the first ring 19 is positioned to bear against the bearing surface 20h of the second ring so that in this second embodiment only the second ring 20 of the contact assembly 17 is in contact with the tang 13. Similarly, the first front face 21d of the third ring 21 is positioned to bear against the bearing surface 22h of the fourth ring so that in this second embodiment only the fourth ring 22 is in contact with the tang 13.

In the embodiment shown in FIG. 4, the front face 20d and the contact surface 20g of the second ring 20 are disposed in contact with the first lateral face 13a of the tang 13. In a variant embodiment, the front face 20d and the contact surface 20g of the second ring 20 may be disposed facing the first lateral face 13a of the tang 13 with a slight clearance possibly being present between the first lateral face 13a of the tang 13 and the second ring 20.

Similarly, in the embodiment shown in FIG. 4, the front face 22d and the contact surface 22g of the fourth ring 22 are disposed in contact with the second lateral face 13b of the tang 13. In a variant embodiment, the front face 22d and the contact surface 22g of the fourth ring 22 may be disposed facing the second lateral face 13b of the tang 13 with a slight clearance possibly being present between the second lateral face 13b of the tang 13 and the fourth ring 22.

The periphery of the radial flange 29 of the second ring 20 and the periphery of the radial flange 30 of the fourth ring 22 may advantageously each comprise a chamfer. The periphery of the radial flange 31 of the first ring 19 and the periphery of the radial flange 32 of the third ring 21 may advantageously also each comprise a chamfer.

In accordance with one embodiment, the first, second, third and fourth rings 19, 20, 21 and 22 may constitute a single portion formed by the axial portions 19a, 20a, 21a and 22a, respectively. The material of the tang 13 may advantageously comprise a metal, for example aluminum or an aluminum alloy. The material of the first and second connecting portions 14 and 15 of the clevis 12 may advantageously comprise a thermoplastic or thermoset matrix reinforced with carbon fibers. The carbon fiber reinforcements that improve the mechanical properties of the first and second connecting portions 14 and 15 of the clevis 12 may be recycled, for example by pyrolysis or steam-thermolysis, after the fixing assembly 11 is discarded, for some other future use.

The material of the first and second contact assemblies 17 and 18 may advantageously comprise a plastic material, a plastic material reinforced with fibers, such as glass fibers, or a metal or an alloy, such as a stainless steel or titanium.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved fixing assemblies for clevises and pins.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A fixing assembly comprising:
a clevis having a first arm having a bore and a second arm having a bore,
a tang having a bore, the tang extending between the first arm and the second arm,
a clevis pin extending through the bore of the first arm, the bore of the tang and the bore of the second arm, the clevis pin connecting the tang to the clevis, and
a first contact assembly comprising a first cylinder having a bore and a first flange and a second cylinder having a bore and a second flange, the first cylinder extending into the bore of the first arm from a first side of the first arm and the second cylinder extending into a portion of the bore of first cylinder located inside the bore of the first arm from a second side of the first arm, the first flange or the second flange axially facing or contacting a first lateral face of the tang, and
wherein a first axial space exists between the first arm and the first lateral face of the tang.

2. The fixing assembly according to claim 1,
including a second contact assembly comprising a third cylinder having a bore and a third flange and a fourth cylinder having a bore and a fourth flange, the third cylinder extending into the bore of the second arm from a first side of the second arm and the fourth cylinder extending into a portion of the bore of the third cylinder located inside the bore of the second arm from a second side of the second arm, the third flange or the fourth flange axially facing or contacting a second lateral face of the tang,
wherein a second axial space exists between the second arm and the second lateral face of the tang.

3. The fixing assembly according to claim 2,
wherein the first flange or the second flange has a contact surface contacting the first lateral face of the tang, and
wherein the third flange or the fourth flange has a contact surface contacting the second lateral face of the tang.

4. The fixing assembly according to claim 2,
wherein the first flange or the second flange has a bearing surface contacting the first side or the second side of the first arm, and
wherein the third flange or the fourth flange has a bearing surface contacting the first side or the second side of the second arm.

5. The fixing assembly according to claim 2,
wherein the first lateral side of the tang faces the second side of the first arm and the second lateral side of the tang faces the first side of the second arm.

6. The fixing assembly according to claim 5,
wherein the first flange has a contact surface contacting the first lateral side of the tang and a bearing surface contacting the second side of the first arm and the second flange has a contact surface contacting the first side of the first arm, or
wherein the second flange has a contact surface contacting the first lateral side of the tang and a bearing surface contacting the second side of the first arm and the first flange has a bearing surface contacting the first side of the first arm.

7. The fixing assembly according to claim 5,
wherein the first flange has a contact surface contacting the first lateral side of the tang and a bearing surface contacting the second side of the first arm and the second flange has a contact surface contacting the first side of the first arm, and
wherein the third flange has a contact surface contacting the second lateral side of the tang and a bearing surface contacting the first side of the second arm and the fourth flange has a bearing surface contacting the second side of the second arm.

8. The fixing assembly according to claim 5,
wherein the second flange has a contact surface contacting the first lateral side of the tang and a bearing surface contacting the second side of the first arm and the first flange has a bearing surface contacting the first side of the first arm, and
wherein the fourth flange has a contact surface contacting the second lateral side of the tang and a bearing surface contacting the first side of the second arm and the third flange has a bearing surface contacting the second side of the second arm.

9. The fixing assembly according to claim 5,
wherein the first and second arms comprise a thermoplastic matrix reinforced by carbon fibers or a thermoset matrix reinforced by the carbon fibers.

10. The fixing assembly according to claim 9,
wherein the tang comprises aluminum or an aluminum alloy.
